(19) United States
(12) Patent Application Publication
(10) Pub. No.: US 2026/0270381 A1
(43) Pub. Date: Sep. 10, 2026

(54) METHOD FOR DECONVOLUTION OF ACQUIRED RAW DATA OF AN IMAGE

(71) Applicant: CARL ZEISS MICROSCOPY GMBH, Jena (DE)

(72) Inventors: Stanislav Kalinin, Weimar (DE); Thomas Egloff, Jena (DE); Volodymyr Kudryavtsev, Jena (DE)

(21) Appl. No.: 19/557,993

(22) Filed: Mar. 5, 2026

(30) Foreign Application Priority Data
Mar. 5, 2025 (DE) 10 2025 108 430.0

(51) Int. Cl. H04N 13/282; H04N 13/189; H04N 25/40; H04N 25/441

(52) U.S. Cl. CPC H04N 13/282; H04N 13/189; H04N 25/41; H04N 25/441

(57) ABSTRACT

A method for deconvolution of acquired raw data of an image includes scanning an object along scanning lines and imaging detection radiation onto a detector array. During a scanning operation, the detector array moves relative to the object along a first scanning strip to acquire raw data from N≥2 detector elements situated in different detector lines. Subsequent scanning operations continue along additional scanning strips offset in the direction of detector columns such that at least one potential scanning line is omitted, making the number of scanning strips equal to 1/N of the lines in the reconstructed image. The raw data is deconvolved pixel-by-pixel using a calculation specification that incorporates a matrix. The matrix elements, mᵢ, indicate the relationship between actually acquired and potential scanning lines to match raw data size to the reconstructed image size, thereby reducing artifacts such as striping.

### CROSS REFERENCE TO RELATED APPLICATION

This application claims priority to German Application No. 102025108430.0, filed Mar. 5, 2025, the disclosure of which is incorporated herein by reference in its entirety.

### TECHNICAL FIELD

The invention relates to a method for deconvolution of acquired raw data of an image according to the preamble of the independent claim.

### BACKGROUND

In the field of microscopic imaging, it is necessary that raw images of an image of an object to be imaged, these being acquired by means of an image acquisition method, in particular by means of a microscopy method, are computed in order to reduce unwanted influences on the image measurement values that have occurred during image acquisition. In order to carry out this procedure, also known as deconvolution, a number of techniques and algorithms are known in the prior art (e.g. Biggs, D. S. C. Andrews, M. (1997), Acceleration of iterative restoration algorithm; Applied Optics 36:1766-1775; DE 10 2019 100 184 A1).

One commonly used algorithm is the Richardson-Lucy algorithm, also known as the Lucy-Richardson algorithm (see, for example, Nicolas Dey, Laure Blanc-Féraud, Christophe Zimmer, Pascal Roux, Zvi Kam, et al. 3D Microscopy Deconvolution using Richardson-Lucy Algorithm with Total Variation Regularization. [Research Report] RR-5272, INRIA. 2004, pp. 71. inria-00070726).

The basic form of the Richardson-Lucy algorithm, also shortened hereinafter to RL algorithm, is directed at the iterative deconvolution of raw data of an image that were recorded at only one acquisition angle or from only one acquisition direction.

If, by contrast, raw data originating from acquisitions at different angles (“multiview”) are intended to be used for deconvolution, a modifier term (“object-modifier”, see also below) can be averaged over the number of acquisition angles or acquisition directions (in this respect, see for example: Temerinac-Ott, M. (2010) Tile-based Lucy-Richardson Deconvolution Modeling a Spatially-Varying PSF for Fast Multiview Fusion of Microscopical Images; Technical Report 260).

The RL algorithms known from the prior art and their adaptations to multiview recordings assume that the size, in particular, the number of the raw data with respect to, for example, the number of raw data elements in x, y and/or optionally z is equal to the size of the image elements of the reconstructed image.

However, if a so-called array detector is used to acquire the raw data and, by means of this detector, selected raw data are recorded simultaneously by means of a plurality of detector elements, the assumption of the same size of raw data elements and reconstructed image elements is no longer necessarily a given. For each acquisition operation, the number of raw data elements present is then less than the number of image elements of the reconstructed image (e.g. DE 10 2019 107 267 A1).

In such a situation, if measurement values of missing, raw data elements are sweepingly filled with the value zero, or if measurement values are interpolated and used in the known calculation specifications (see also equations 1 and 2 below), this disadvantageously results in distinct striping in the reconstructed images.

### SUMMARY

The techniques described herein are based on the object of proposing a method for deconvolution of acquired raw data of an image in which the sizes of their raw data are different from those of the reconstructed image.

Described methods serve for deconvolution of acquired raw data of an image, wherein the raw data of an object to be imaged are provided on account of a plurality of acquisitions from different directions (acquisition directions). Such image recordings may also be referred to as multiview images or multiview recordings.

In order to acquire the raw data, an object to be imaged is scanned along scanning lines and the detection radiation acquired in the process is imaged onto a detector array (also referred to hereinafter as: detector or array detector). Detector elements (pixels) of the detector array are arranged in detector lines and detector columns. During the scanning of the object, the detector array is moved relative thereto and in the direction of the detector lines along a respective scanning line. A used detector with a detector array is embodied in such a way that measurement values of each of the detector elements can be selectively read out and processed.

During each scanning operation, along a scanning strip comprising a number of scanning lines, raw data are acquired by a number N, where N≥2, of detector elements (pixels) situated in different detector lines. This means that at least two image lines are recorded each time a scanning strip is swept over. The parameter N, also referred to below as parallelization factor P, may be regarded as the step size of the scanning in the slow scan direction transversely with respect to the detector lines.

Once the raw data of a scanning strip are acquired, the scanning operation is continued along a next scanning strip, wherein the next scanning strip is offset in the direction of the detector columns by the extent of the pixels used for scanning. With respect to the individual detector elements or pixels, that has the effect that at least one potential scanning line is omitted and, as a result, the number of scanning lines is equal to 1/N of the number of image lines of the image to be reconstructed. The number of scanning lines actually swept over with a specific pixel is therefore less than the number of image lines of the image to be reconstructed (in this respect, see also DE 10 2019 203 448 A1).

For computational deconvolution, a calculation specification is used by means of which the raw data are deconvolved, in particular iteratively.

In some implementations, a method is characterized in that the calculation specification comprises a matrix, the matrix elements of which indicate the potential scanning lines and the actually acquired scanning lines and the contents thereof, so that the size of the raw data corresponds again to the size of the image as a result. A computation of the raw data by means of the calculation specification, in particular, a division, is carried out pixel by pixel.

In some implementations, a matrix in introduced whose information content allows the size of the raw data, for example, the number of scanning lines, to be adapted to the size of the image to be reconstructed. It is additionally possible for the matrix elements to indicate an intensity or a value or a relative proportion of an acquired intensity. With the aid of the matrix, it is thus possible virtually to carry out a distribution of acquired measurement values, in particular acquired intensity values, among the pixels.

Terms are used hereinafter whose meanings are briefly explained below.

Raw data are understood here to be acquired measurement values, the evaluation of which leads to image data and an image as a result. Furthermore, preprocessed images are also understood as raw data (also: secondary raw data), which are subsequently deconvolved within the meaning of the invention.

A reconstructed image is composed of a set of image elements (pixels). These image elements correspond to detector elements of the detector used for image acquisition. For simplification, therefore, detector elements and image elements are also referred to as pixels. The same applies, mutatis mutandis if an image is to be composed of a set of partial images.

The acquired measurement values (raw data) need to be deconvolved in order to obtain the most error-free image possible of the object to be imaged. Such an image of the object largely without errors and deviations is also referred to as image to be reconstructed or as reconstructed image.

A scanning line or data line is provided by sweeping over (scanning) the object field to be acquired. With the use of an array detector, the detector elements of the detector scan the object field along the scanning line, wherein it is possible for measurement values to be acquired and further processed only by selected detector elements. A scanning line extends in the fast scan direction and runs parallel to the orientation of the detector lines of the detector array. Each detector line potentially represents a scanning line. For example, if there were a desire to scan the object field by means of a central detector element of the detector array (see also further below), each of the potential scanning lines would have to be used. Acquiring multiple (image) lines by means of a single scan is also known as multiplex recording or multiplexing. Since in the context of the invention, each scanning operation involves simultaneously sweeping over at least two scanning lines and acquiring their measurement values, the term scanning strip is employed below in this connection. The meanings of the terms scanning line, scanning strip and detector line are illustrated in FIG. 1 and explained with reference thereto.

In further configurations of the method, a scanning strip can be scanned in a forward direction and/or in a backward direction, i.e. unidirectionally or bidirectionally (FIG. 1 and, for example, DE 10 2019 203 448 A1).

The point spread function (PSF) indicates a transfer function of information of scanned object points in raw data.

The detector array is preferably arranged in an intermediate image plane (pinhole plane) in a detection beam path. Each of its detector elements acts as an independent pinhole with the aim of confocal image acquisition. The possibility of being able to correlate the measurement values of each detector element with measurement values of at least one selection of the other detector elements allows, inter alia, a resolution of the image to be reconstructed that is below the diffraction-related resolution limit (super-resolution; see also: Huff, J., Bergter, A and Luebbers, B. (2019), Multiplex mode for the LSM 9 series with Airyscan 2: fast and gentle confocal super-resolution in large volumes; Nature methods October 2019).

Various possibilities and modifications of a computational deconvolution are known from the prior art. One of these is the Richardson-Lucy algorithm (Richardson-Lucy deconvolution; RL algorithm), already discussed in the introduction. Its general form reads:

$${o}_{k + 1} = {o}_{k} [ h ( - x ) * \frac{d ( x )}{( h * o ) ( x )} ] \qquad ( 1 )$$

where
oₖ is the reconstructed object (image) after k iterations;
h is the (respective) point spread function PSF;
h(−x) is the mirrored PSF;
d is the measured measurement values/raw data; and
the expression in parentheses

$$[ h ( - x ) * \frac{d ( x )}{( h * o ) ( x )} ]$$

is the “object modifier”.

The * symbol indicates the convolution operation.

The term (h*o) denotes a theoretical model of the acquired measurement values (raw data) and represents a so-called “forward model” (e.g. Dey, N.,-Féraud, L. B., Zimmer, C., Roux, P., Kam, Z. et al. (2004), 3D Microscopy Deconvolution using Richardson-Lucy Algorithm with Total Variation Regularization [Research Report] RR-5272, INRIA).

In order to be able to handle the application of an acquisition from different viewing or acquisition directions (multiview), a modification of the initial equation was proposed with equation (2) (Temerinac-Ott, M. (2010) Tile-based Lucy-Richardson Deconvolution Modeling a Spatially-Varying PSF for Fast Multiview Fusion of Microscopical Images; Technical Report 260):

$${o}_{k + 1} = {o}_{k} {\sum }_{i = 1}^{N} [ {h}_{i} ( - x ) * \frac{{d}_{i} ( x )}{( {h}_{i} * o ) ( x )} ] / N . \qquad ( 2 )$$

N indicates the number of acquisition directions or simultaneously acquired image lines and should not be confused with the step size N along the slow scan direction explained above. As already discussed above, equations (1) and (2) assume that the raw data have the same size as the image data of the reconstructed image. This assumption is not a given in the case of parallel measurement value acquisition of pixels or entire lines.

The problem can be resolved conditionally with the formation of Sheppard sums and their correction with regard to Y- or X-dependent intensity variances. These Sheppard sums corrected in this way, which are regarded as precomputed raw data (secondary raw data) for the purposes of the description, can be used for example in equation (1). However, part of the information is lost in the course of this step-by-step algorithm. In addition, eliminating striping (“destriping”) involves multiplying the raw data by location-dependent factors, which causes a condition of the RL algorithm, namely Poisson-distributed noise, to be violated.

These constraints and limitations led to a configuration of the method according to the invention in which the calculation specification used is extended as follows:

$${o}_{k + 1} = {o}_{k} \frac{{\sum }_{i} [ {h}_{i} ( - x ) * \frac{{d}_{i} ( x )}{( {h}_{i} * o ) ( x )} ]}{{\sum }_{i} [ {h}_{i} ( - x ) * {m}_{i} ( x ) ]} \qquad ( 3 )$$

The terms and variables have the meanings given for equation 1.

As a feature of significance for the invention, the denominator contains the expression Σᵢ[hᵢ(−x)*mᵢ(x)]. The expression mi denotes the matrix whose information content, for example with respect to scanning lines not explicitly scanned, as a result leads to an equal size of raw data and image to be reconstructed.

The point spread functions hi used in equation (3), also referred to hereinafter just as PSF for short, can be determined in various ways and used in the method according to the invention. Firstly, the PSFs can be calculated as theoretical PSFs on the basis of theoretical considerations and constraints. Moreover, it is possible to derive the PSFs from the raw data acquired or to apply test measurements and calibrations, for example on the basis of known reference samples, in order to determine the point spread functions hi.

The point spread functions hi used in equation (3) for acquisition from one viewing direction or one detector line (channel), for example, are not individually normalized for each channel. For example, if one detector element acquires a lower intensity than other detector elements, the contribution of the associated PSF is likewise lower than that of the other detector elements.

The procedure when implementing the method according to the invention can be explained using the following example: Assuming that every fourth potential scanning line (e.g. scanning line 1, 5, 9, . . . ) of a detector with detector elements arranged line by line is intended to be used in acquisition of measurement values, in the matrix mi the corresponding matrix elements are set to the value “1”, and all other lines of the matrix elements can be allocated the value “0”.

In order to generate a resulting (overall) image by means of the method according to the invention, the images (to be reconstructed) obtained from the deconvolved raw data can be merged.

In a further configuration of the method according to the invention, precomputed raw images that are based on raw data, and here are also referred to as secondary raw data, can be used as the basis of the deconvolution (see e.g. DE 10 2019 107 267 A1).

The formation of Sheppard sums can be applied as precomputation. If the object to be imaged is intended to be scanned in a forward direction and in a backward direction, a Sheppard sum for the even-numbered lines and a further Sheppard sum for the odd-numbered lines are advantageously calculated. In this way, there is in each case a separate Sheppard sum for the forward direction and the backward direction. It is not necessary to correct any striping that may be present in the results. The raw images precomputed with the formation of the Sheppard sums can be regarded as counting data and deconvolved as secondary raw data using the algorithm according to equation (3).

Precomputation additionally allows acquired intensity values to be distributed among pixels. While the matrix elements have either the value “0” or “1” in measurement value acquisition and imaging in the black-and-white mode, matrix elements can also have values of between “0” and “1”, for example 0.25 or 0.5, in a precomputation.

Precomputed raw images are preferably not corrected with regard to nonuniform illumination. For example, vertical and/or horizontal stripes caused by nonuniform illumination are therefore not eliminated.

The matrix mi used in the method according to the invention allows the handling and reduction of known disadvantages in the deconvolution of multiplex images. The matrix elements indicate an expected intensity when a homogeneous object is present. For example, the values of the matrix elements mi(x) can be determined on the basis of theoretical point spread functions of the respective pixels. It is also possible to take account of the mode for generating the raw data and to determine the values of the matrix elements accordingly. For example, if a “black-and-white mode” is selected, the matrix values can be allocated in binary form (0, 1). By contrast, if provision is made for using precomputed raw images as input data for the calculation specification, in particular according to equation (3), expected intensity values can also be distributed proportionally among pixels with which the measurement values of the scanning are currently not acquired.

In a further possible procedure, the values of the matrix elements mi(x) are determined on the basis of the raw data. In this case, measurement values of pixels with expected presence of a valid measurement value in particular for each scanning line actually acquired are averaged and correlated relative to the average intensity over the entire image. The assumption here is that there is no correlation between any possible stripe pattern and actual image structures.

Scan errors may occur during the scanning of the object, and may be caused for example by slight mechanical play, mass inertias and tolerances of the optical elements involved (see e.g. DE 10 2019 107 267 A1). Such scan errors can be reduced during deconvolution.

For this purpose, the calculation specification can be supplemented with a correction term of the form

$${h}_{i} ( - {x}_{d} ) * \frac{{d}_{i} ( x )}{( {h}_{i} * o ) ( {x}_{d} )} , \qquad ( 4 )$$

wherein x_{d} indicates a positioning error and (hᵢ*o) (x_{d}) is an error-based model (forward model).

The positioning error x_{d} can be determined and made available in a first step, for example in the course of a calibration.

In a step two, the error-based model (forward model) (hᵢ*o) (x_{d}) is calculated with new coordinates.

A third step reverses again the process from step two with the term according to equation (4). The deconvolution is then carried out with the adapted calculation specification

$${o}_{k + 1} = {o}_{k} \frac{{\sum }_{i} [ {h}_{i} ( - {x}_{d} ) * \frac{{d}_{i} ( x )}{( {h}_{i} * o ) ( xd )} ]}{{\sum }_{i} [ {h}_{i} ( - {x}_{d} ) * {m}_{i} ( x ) ]} \qquad ( 5 )$$

If different scan errors occur during scanning of the object to be imaged in a forward direction and in a backward direction, positioning error xd and error-based model (forward model) (hᵢ*o)(x_{d}) can be determined and applied for each direction.

An alternative correction option, in particular with respect to steps two and three mentioned above, is that a correction of positioning errors or of an erroneous model for the raw data of different acquisition directions is carried out by means of a transformation to a common coordinate system (“common image grid”) of all the raw data. Such a transformation can be indicated with

$${d}_{i} ( {x}_{d} ( i ) ) \to {d}_{i} ( x ) . \qquad ( 6 )$$

The Richardson-Lucy algorithm is an iterative method. The latter as a computational solution step-by-step keeps on approximating to a limit value while complying with the method-specific constraints. The approximation takes place in smaller and smaller steps as the number of iterations increases. In some cases, the solution may also move away again from a limit value as the iteration process progresses.

It is therefore advantageous to additionally apply an algorithm for increasing the efficiency of the deconvolution. In one variant, after each iteration of the deconvolution, a future of the current calculation values with regard to a convergence to a limit value for each image element is estimated. In this case, the future can be determined as a direction vector from a difference between function values of a current iteration and the preceding iteration (Biggs, D. S. C., Andrews, M. (1997), Acceleration of iterative restoration algorithm; Applied Optics 36:1766-1775; DE 10 2021 129 159 A1).

In order to terminate the algorithm when a current solution has sufficiently approximated to a limit value, parameter values for constraints of the calculation specification can be estimated and applied. Advantageously, for example, the constraints can be determined by means of the method of total variation or the Tikhonov-Miller algorithm (Temerinac-Ott, M. (2010) Tile-based Lucy-Richardson Deconvolution Modeling a Spatially-Varying PSF for Fast Multiview Fusion of Microscopical Images; Technical Report 260; Dey, N.,-Féraud, L. B., Zimmer, C., Roux, P., Kam, Z. et al. (2004), 3D Microscopy Deconvolution using Richardson-Lucy Algorithm with Total Variation Regularization [Research Report] RR-5272, INRIA).

In a further configuration of the method according to the invention, in each scanning operation along a scanning line, raw data of every n-th detector column, where n≥2, are acquired. Analogously to the parameter N, in this method configuration the parameter n can be regarded as a step size in the fast scan direction. Depending on the selection of the parameters N and/or n, the raw data set is smaller than the data set of the reconstructed image. In one configuration, the matrix mi can be designed in such a way that every second line and every second column are occupied by a value greater than zero. In this configuration, each matrix element is surrounded by matrix elements with the content “0”. The “upsampling” procedure can be combined with raw data per se or with secondary raw data.

This method configuration allows an “upsampling” without interpolation of missing raw data, so that the conditions of the RL algorithm are complied with. For this purpose, the PSF can be determined by means of sampling that corresponds to the scanning of the image to be reconstructed. Consequently, the image data could be reconstructed by means of Nyquist sampling, even if the size of the raw data is smaller than the size of the reconstructed image.

### BRIEF DESCRIPTION OF THE FIGURES

FIG. 1 schematically shows a number of pixels Pxn (i=1, 2, 3, . . . ,), which adjoin one another and are assembled to form a compound structure.

FIG. 2 visualizes by way of example three possible embodiments of the matrix mᵢ for one of the pixels Px1 to Px4.

### DETAILED DESCRIPTION

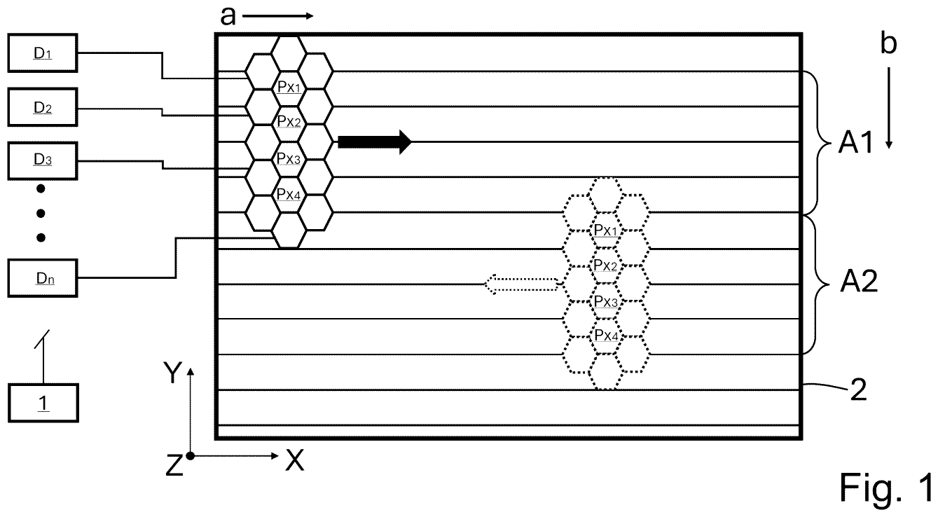

The terms scanning line, scanning strip and detector line are elucidated with reference to FIG. 1, which schematically shows a number of pixels Pxn (i=1, 2, 3, . . . ,), which adjoin one another and are assembled to form a compound structure. The pixels Pxn shown can be equated with detector elements of a detector array.

The pixels Pxn of the detector array are arranged in detector lines alternately mutually offset by half a pixel height with respect to one another parallel to the direction of the potential scanning lines a (fast scan direction) and in detector columns orthogonal thereto (direction b, slow scan direction).

The measurement values can be read out individually and selectively for each pixel Pxn. That can be done for example by means of detectors D1, D2, D3, . . . , Dn (i=1, 2, 3, . . . , n) assigned to the respective pixels Pxn. The detectors D1, D2, . . . , Dn are optionally connected to an evaluation unit 1 in a manner suitable for the transfer of data.

The measurement values are acquired by virtue of the pixels Pxn being guided along the potential scanning lines a in an object plane 2. The totality of the potential scanning lines a would have to be scanned at least once by each of the pixels Pxn if the intention is to acquire measurement values of each pixel Pxn for all the potential scanning lines a. Such a procedure is carried out for example in the case of standard scanning of a sample by means of an Airyscan detector (Huff, J. (2016) The Fast mode for the ZEISS LSM 880 with Airyscan: high-speed confocal imaging with super-resolution and improved signal-to-noise ratio, Nature Methods: November 2016.)

In the example shown, the pixels are scanned in direction a (slow scan direction). The pixels Px1 to Px4 are shifted along the potential scanning lines 2, 3, 4 and 5 in direction a. The pixels Px1 to Px4 simultaneously scan four potential scanning lines, and thus as a result four image lines, during a scan movement. The measurement values of the further pixels shown are optionally used to evaluate and improve the resolution of the measurement values obtained by means of the pixels Px1 to Px4.

During the forward scan, the totality of the potential scanning lines 2 to 5 are swept over once by the pixels Px1 to Px4. This strip scanned by the pixels Px1 to Px4 is referred to as the first scanning strip A1.

For the return scan, the pixels Pxn (illustrated using dashed lines) are shifted in direction b by a parallelization factor P. In the illustrated exemplary embodiment, P=4 lines. During the backward scan, the pixels Px1 to Px4 scan the potential scanning lines 6 to 9 (scanning strip A2).

The individual pixels Px1 to Px4 always sweep over a fourth-next potential scanning line. For example, the pixel Px1 is used to acquire measurement values of the potential scanning lines 2, 6, 10, . . . , etc.

During the forward scan in the forward direction, the image data of each pixel Pxn are acquired and stored line-by-line. The pixels Pxn are then offset for the return scan in the backward direction in accordance with the parallelization factor P. From the acquired image data, reconstructed image data and a reconstructed image are calculated using reconstruction methods, for example using a deconvolution function.

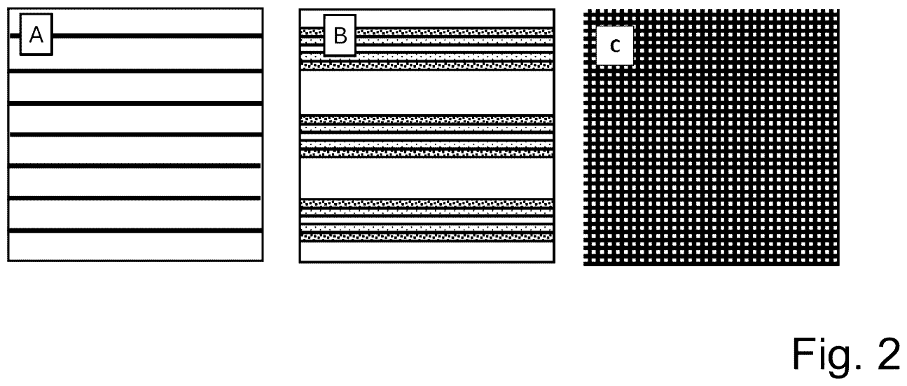

FIG. 2 visualizes by way of example three possible embodiments of the matrix mi for one of the pixels Px1 to Px4. Subfigure A illustrates a configuration of the invention in which raw data for example of the pixel Px1 are acquired and their expected contents are defined by means of the matrix mi. Subfigure B is concerned with precomputed images. Intensities are distributed among multiple matrix elements according to their expectations in the fast and slow scan directions. Subfigure C illustrates so-called “upsampling” both in the fast scan direction a and in the slow scan direction b.

### REFERENCE SIGNS

1 Evaluation unit
2 Object plane
a Fast scan direction
b Slow scan direction
A1, A2 Scanning strips
D1, D2, D3, . . . , Dn Detectors
Px1 to Px4 Pixels

1. A method for deconvolution of acquired raw data of an image to be reconstructed, the method comprising:
scanning an object to be imaged along scanning lines for the acquisition of the raw data, wherein the scanning includes imaging detection radiation acquired from the object onto a detector array, wherein detector elements (pixels Pxₙ) of the detector array are arranged in detector lines and detector columns;
moving, during a scanning operation involving the scanning of the object, the detector array relative to the object and in the direction of the detector lines along a first scanning strip that includes a number of the scanning lines;
acquiring, during a scanning operation along the first scanning strip, raw data from a number N (N≥2) of detector elements Pxₙ situated in different detector lines;
after the acquisition of raw data from detector elements during the scanning operation along the first scanning strip, continuing the scanning operation by:
moving the detector array relative to the object and in the direction of the detector lines along a second scanning strip that includes a number of the scanning lines;
acquiring, during a scanning operation along the second scanning strip, raw data from a number N (N≥2) of detector elements Pxₙ situated in different detector lines, wherein the second scanning strip is offset in the direction of the detector columns at least by an extent of the pixels Pxₙ used for scanning, such that at least one scanning line of the first scanning strip is omitted from the second scanning strip, and wherein the number of scanning strips is equal to 1/N of the number of image lines of the image to be reconstructed; and
deconvolving the acquired raw data with a calculation specification that includes a matrix (mᵢ), the matrix elements mᵢ(x) of which indicate the first and second scanning strips and the contents thereof, so that the size of the raw data corresponds to the size of the image as a result, wherein deconvolving the acquired raw data with the calculation specification is carried out pixel by pixel.

2. The method of claim 1, wherein the calculation specification includes the calculation:
$${o}_{k + 1} = {o}_{k} \frac{{\sum }_{i} [ {h}_{i} ( - x ) * \frac{{d}_{i} ( x )}{( {h}_{i} * o ) ( x )} ]}{{\sum }_{i} [ {h}_{i} ( - x ) * {m}_{i} ( x ) ]} ,$$
wherein:
oₖ represents the reconstructed object (image) after k iterations;
hᵢ represents the respective point spread function PSF;
hᵢ(−x) represents the inverted PSF;
dᵢ represents the measured measurement values/raw data;
* indicates a convolution operation;
the expression in brackets
$${\sum }_{i} [ {h}_{i} ( - x ) * \frac{{d}_{i} ( x )}{( {h}_{i} * o ) ( x )} ]$$
represents an “object modifier”;
(h*o) denotes a theoretical model of the measured data; and
mᵢ represents the matrix.

3. The method of claim 1, wherein precomputed raw images based on raw data are used as a basis of the deconvolution.

4. The method of claim 3, wherein the precomputed raw images are not corrected with regard to a nonuniform illumination.

5. The method of claim 3, wherein the values of the matrix elements mᵢ(x) are determined on the basis of theoretical point spread functions or on the basis of an envisaged use of the raw data or of the precomputed raw data.

6. The method of claim 3, wherein the values of the matrix elements mᵢ(x) are determined on the basis of the raw data, wherein measurement values of pixels Pxₙ with expected presence of a valid measurement value or scanning lines (A1, A2) are averaged and correlated relative to the average value over all measurement values dᵢ.

7. The method of claim 1, wherein in each scanning operation along the first and second scanning strips, raw data of every n^{th} detector column are acquired, where n≥2.

8. The method of claim 2, wherein the calculation specification is supplemented with a correction term of the form
$${h}_{i} ( - {x}_{d} ) * \frac{{d}_{i} ( x )}{( {h}_{i} * o ) ( {x}_{d} )} .$$
and the deconvolution is carried out according to:
$${o}_{k + 1} = {o}_{k} \frac{{\sum }_{i} [ {h}_{i} ( - {x}_{d} ) * \frac{{d}_{i} ( x )}{( {h}_{i} * o ) ( xd )} ]}{{\sum }_{i} [ {h}_{i} ( - {x}_{d} ) * {m}_{i} ( x ) ]} ,$$
wherein x_{d} indicates a positioning error
and (hᵢ*o)(x_{d}) represents an error-based model.

9. The method of claim 8, wherein during a scanning of an object to be imaged in a direction forward and in a direction backward, respectively adapted correction terms are determined and applied.

10. The method of claim 2, wherein a correction of positioning errors or of an erroneous model for the raw data of different acquisition directions is carried out by means of a transformation to a common coordinate system of all the raw data.

11. The method of claim 1, wherein an algorithm for increasing the efficiency of the deconvolution is additionally applied, in which, after each iteration of the deconvolution, a future of current calculation values with regard to a convergence to a limit value for each image element is estimated.

12. The method of claim 11, wherein the future is determined as a direction vector from a difference between function values of a current iteration and the preceding iteration.

13. The method of claim 1, wherein parameter values for constraints of the calculation specification are estimated and applied.

14. The method of claim 13, wherein the constraints are determined by means of the method of total variation or the Tikhonov-Miller algorithm.
